(19) United States
(12) Patent Application Publication
(10) Pub. No.: US 2014/0139891 A1
(43) Pub. Date: May 22, 2014

(54) SYSTEM PROVIDED WITH SCAN FUNCTION FOR TRANSMITTING E-MAIL AND METHOD FOR TRANSMITTING E-MAIL

(71) Applicant: Young Wan Byun, Suwon-si (KR)

(72) Inventor: Young Wan Byun, Suwon-si (KR)

(21) Appl. No.: 14/129,071

(22) PCT Filed: Jun. 25, 2012
(86) PCT No.: PCT/KR2012/004987

§ 371 Date: Dec. 23, 2013

(30) Foreign Application Priority Data
Jun. 23, 2011 (KR) 10-2011-0061087

(51) Int. Cl. H04N 1/00; H04L 12/58; G06F 3/12

(52) U.S. Cl. CPC H04N 1/00095; G06F 3/1293; H04L 51/06
USPC 358/474

(57) ABSTRACT

A system provided with a scan function for transmitting an e-mail, and to a method for transmitting the email, wherein when a user wants to send an e-mail with a predetermined image as an attachment, the inconvenience of saving image data on a computer of the user through a scanner and then opening same when writing the e-mail is reduced, so as to provide convenience to the user.

### BACKGROUND

The present invention relates to a system provided with a scan function for transmitting e-mail, and in particular to a system provided with a scan function for transmitting e-mail and a method for transmitting e-mail in which when a user requests an attachment of a scanned file to an e-mail while the user is preparing the e-mail, an e-mail preparation unit generates an image data with a scanning unit, and the image data is automatically attached to the e-mail, so a user can more easily use e-mail by reducing inconvenience which used to occur as a user stores in a computer an image data obtained using a scanner and retrieves the stored image data from the computer when the user wants to transmit an e-mail along with a certain image attached to the e-mail.

The present invention is directed to a system provided with a scan function for transmitting e-mail and a method for transmitting e-mail.

Thanks to the developments of electronic technology, various types of computer peripherals are developed and are commercially used. Such computer peripherals are formed of a scanner, a copy machine, a printer, a function-combined machine, etc., which are all called an image formation device capable of forming an image.

In case of an image formation device such as a canner, a copy machine, a function-combined machine, etc. which each are equipped with a scanning function, it is equipped with a scan to e-mail function which makes it possible to directly transmit a scanned image data to an external terminal in the form of an e-mail.

FIG. 1 is a simulated view for describing a general construction of a system which usually performs a scan to e-mail function.

As shown in FIG. 1, the scan to e-mail system comprises an image formation device 10, a mail server 20 and a terminal device 30.

Here the image formation device 10 has features in that a document is canned, and an image data is generated, and an e-mail with the image data attached thereto is generated and transmitted to the mail server 20, and a mail transmission is requested to a designated e-mail address. Afterward, the mail server 20 transmits the e-mail to the terminal device 30 with the designated mail address.

FIG. 2 is a simulation view for describing a construction of an e-mail that a conventional image formation device 10 generally transmits.

When a user confirms on the terminal device 30 the received e-mail, the e-mail content as shown in FIG. 2 is displayed on the display.

As shown in FIG. 2, the mail content is displayed in a simple form, which just informs the user of the arrival of a new e-mail, more specifically, the image data, for example, Scan001.pdf is displayed in an attached file form.

In this case, the user should open the attached file so as to confirm the contents of the image data. When multiple image data are attached, the user needs to open one by one all the image data files.

When the user wants to transmit an a-mail along with the attached image data after editing, the image data are stored in the PC, and the image data are retrieved out and edited using a certain image data editing program (for example, the paint program, the photo shop, etc.), and the edited image data are stored in the PC, and the stored image data are retrieved when attaching it to the e-mail. For these reasons, the user needs to do complicated procedures.

### SUMMARY OF THE INVENTION

Accordingly, the present invention is made so as to improve the above mentioned problems. It is an object of the present invention to provide a system provided with a scan function for transmitting e-mail and a method for transmitting e-mail which have features in that when a user requests an attachment of a scanned file to an e-mail while the user is preparing the e-mail, an e-mail preparation unit generates an image data with a scanning unit, and the image data is automatically attached to the e-mail, so the user's e-mail use can be easier by reducing inconvenience which used to occur as a user stores in a computer an image data obtained using a scanner and retrieves the stored image data from the computer when the user wants to transmit an e-mail along with a certain image attached to the e-mail.

It is another object of the present invention to provide a system provided with a scan function for transmitting e-mail and a method for transmitting e-mail which have features in that when a user requests an attachment of a scanned file to an e-mail while the user is preparing the e-mail, the scanning unit scans, and an image data is generated, and the screen of an output unit is divided into two parts, and the mail content is prepared on one screen, and the image data scanned by the scanning unit are edited on the other screen, so the user can do all the necessary works at a time in easier ways.

To achieve the above object, there is provided a system provided with a scan function for transmitting e-mail configured to transmit e-mail via a network, comprising a scanning unit which generates an image data by performing a scanning work; a mail preparation unit which allows a user to prepare an e-mail, and when a scan request signal is received in the middle of preparation of e-mail, allows the scanning unit to perform a scanning work and allows a preview image of the image data to be outputted via the output unit so that the proceeding state of the scan work to be confirmed, and when an attachment authorization signal is received via an input unit, it allows the image data to be automatically attached to the e-mail; and a mail transmission unit which allows the e-mail prepared by the mail preparation unit to be transmitted to an external transmission unit.

At this time, when a scan request signal is received, the mail preparation unit divides the screen of the output unit into a first divide screen and a second divide screen, and on the first divide screen is prepared a body content of the e-mail, and on the second divide screen is edited an image received from the scanning unit.

In addition, the mail preparation unit allows the image data from the scanning unit to be outputted on the second divide screen and provides an editing tool by which to edit the image data.

Meanwhile, the editing tool comprises an area setting unit for setting a certain area of the image data; a cutting-off unit for cutting off a certain area of the image data; a rotation editing unit for rotating the direction of the image data; a size adjusting unit for adjusting the size of the image data; a color expression adjusting unit for adjusting the color expression of the image data; a brightness adjusting unit for adjusting the brightness of the image data; a text insertion unit for inserting the texts into the image data; a zooming unit for performing a zooming-in or zooming-out function of the image data; and a returning unit for allowing the current routine to the previous editing routine when the image data has been edited.

In addition, when the editing of the image data is completed by the editing tool, the mail preparation unit allows the edited image data to be automatically attached to the e-mail.

To achieve the above objects, there is provided a method for transmitting an e-mail using a system provided with a scan function for transmitting e-mail configured to transmit e-mail via a network, comprising a step (A) in which a mail preparation unit receives a scan request signal in the middle of preparation of an e-mail; a step (B) in which when the mail preparation unit receives a scan request signal in the step (A), the scanning unit is commanded to perform a scanning work; a step (C) in which the mail preparation unit divides the screen of an output unit into a first divide screen and a second divide screen, and the content of the body of the e-mail is inputted via the first divide screen, and the image data generated in the step (B) is edited on the second divide screen; and a step (D) in which when the mail preparation unit receives an image data attachment authorization signal via the input unit, the image data is automatically attached to the e-mail; and a step (E) in which when the mail transmission unit receives a request for transmitting an e-mail prepared in the step (D), it transmits the e-mail to an external terminal device via the network.

At this time, in the step (C), the image data generated in the step (B) are outputted on the second divide screen, and there is provided an editing tool by which to edit the image data.

In addition, the editing unit comprises an area setting unit for setting a certain area of the image data; a cutting-off unit for cutting off a certain area of the image data; a rotation editing unit for rotating the direction of the image data; a size adjusting unit for adjusting the size of the image data; a color expression adjusting unit for adjusting the color expression of the image data; a brightness adjusting unit for adjusting the brightness of the image data; a text insertion unit for inserting the texts into the image data; a zooming unit for performing a zooming-in or zooming-out function of the image data; and a returning unit for allowing the current routine to the previous editing routine when the image data has been edited.

According to the present invention, when a user requests an attachment of a scanned file to an e-mail while the user is preparing the e-mail, an e-mail preparation unit generates an image data with a scanning unit, and the image data is automatically attached to the e-mail, so the user's e-mail use can be easier by reducing inconvenience which used to occur as a user stores in a computer an image data obtained using a scanner and retrieves the stored image data from the computer when the user wants to transmit an e-mail along with a certain image attached to the e-mail.

In addition, the present invention have features in that when a user requests an attachment of a scanned file to an e-mail while the user is preparing the e-mail, the scanning unit scans, and an image data is generated, and the screen of an output unit is divided into two parts, and the mail content is prepared on one screen, and the image data scanned by the scanning unit are edited on the other screen, so the user can do all the necessary works at a time in easier ways.

### BRIEF DESCRIPTION OF DRAWINGS

FIG. 1 is a view illustrating the whole construction of a conventional system provided with a scan to e-mail function.

FIG. 2 is a view illustrating the operations of a conventional system provided with a scan to e-mail function.

FIG. 3 is a block diagram illustrating an internal construction of a system provided with a scan function for transmitting e-mail according to a preferred embodiment of the present invention.

FIGS. 4 to 10 are views for describing the operations of a system provided with a scan function for transmitting e-mail according to the present invention.

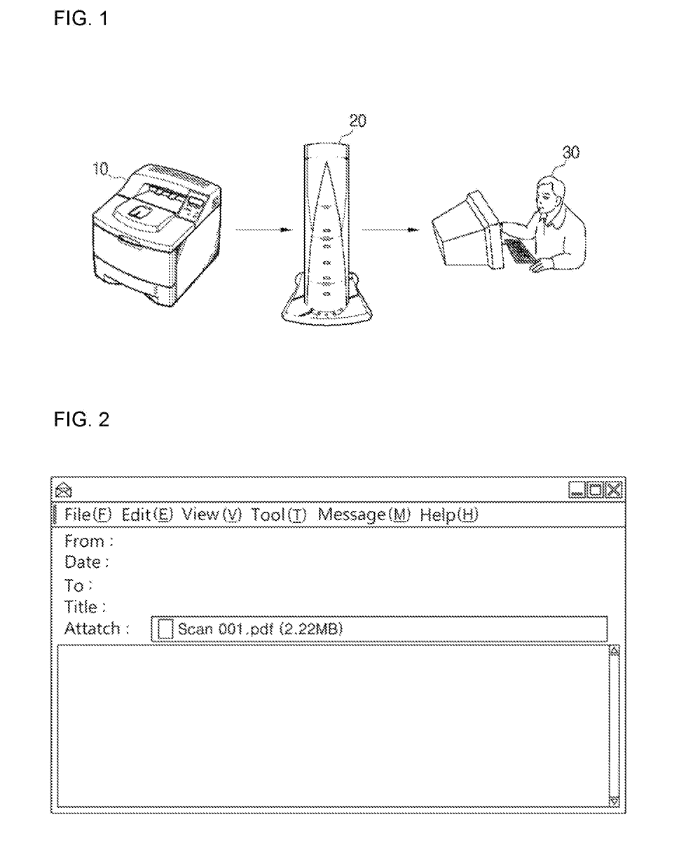

### DETAILED DESCRIPTION OF THE INVENTION

The system provided with a scan function for transmitting e-mail according to a preferred embodiment of the present invention will be described with reference to the accompanying drawings.

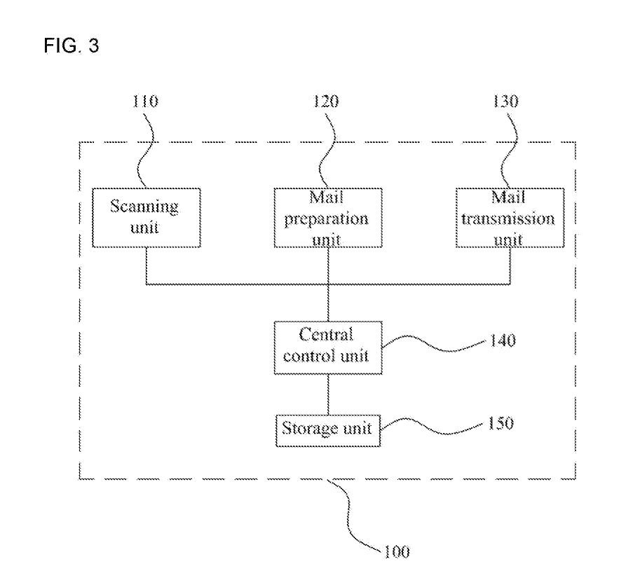

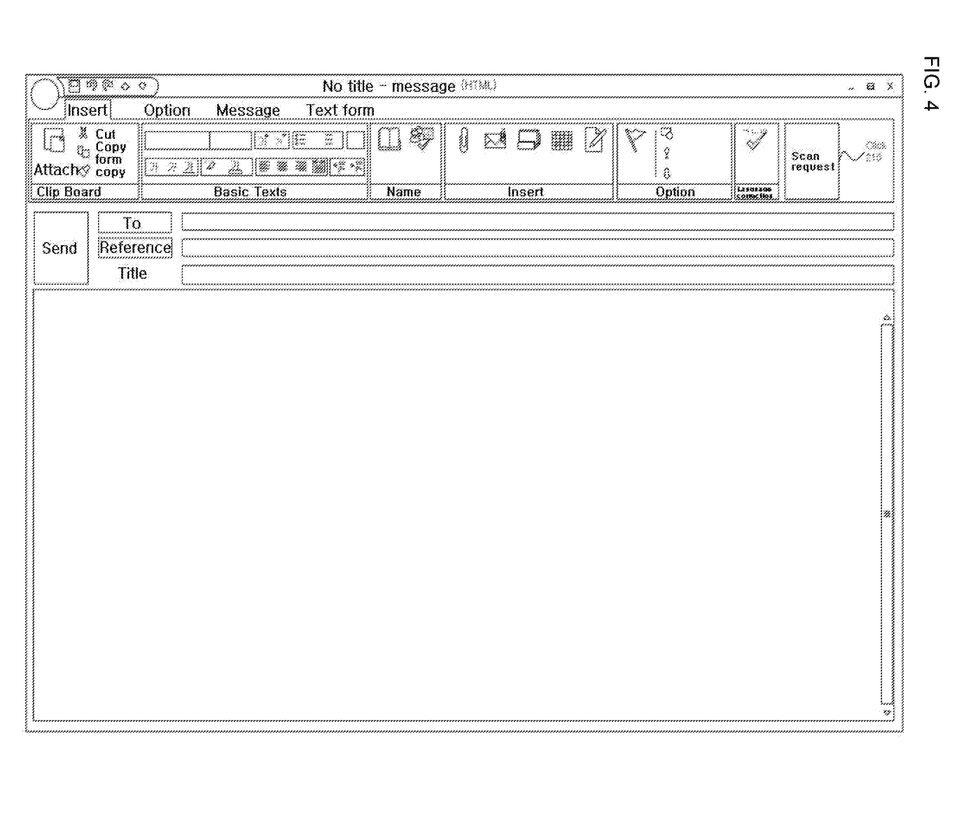

FIG. 3 is a block diagram illustrating an internal construction of a system provided with a scan function for transmitting e-mail according to a preferred embodiment of the present invention.

As shown in FIG. 3, the system provided with a scan function for transmitting e-mail according to the present invention comprises a scanning unit 110, a mail preparation unit 120, a mail transmission unit 130, a central control unit 140 and a storage unit 150.

The scanning unit 110 performs a scanning work and generates an image data. More specifically, the scanning unit 110 generates an image data in such a way that a user positions in place a file (for example, a document, a photo, etc.) at a mounting portion and inputs a scanning command, and the documents are read by a reading means such as a CCD (Charge Coupled Device), and the image data are generated based on the read contents. At this time, the image data are generated in various image formats such as pdf, bmp, tiff, etc.

The mail preparation unit 120 allows the user to prepare e-mail. When a scan request signal is received via a scan request icon 210 in the middle of the e-mail preparation, the scanning work is performed by the scanning unit 110, and a preview image of the image data is displayed on the output unit so that the proceeding state of the scan work can be viewed. Here, the preview image means an image the size of which is decreased at a certain aspect ratio so that a schematic configuration of the image data scanned by the scanning unit 110 can be confirmed.

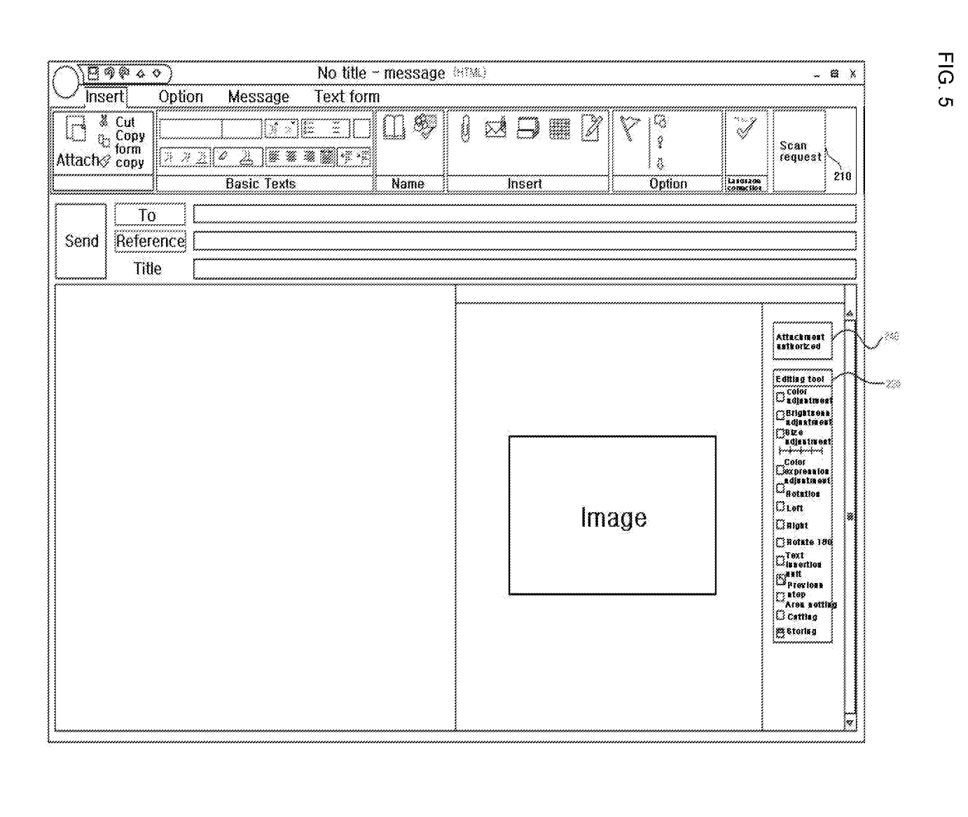

When an attachment authorization signal for the image data is received via the input unit, the image data are automatically attached to the e-mail. FIG. 3 is a view for describing the operations of the e-mail transmission system provided with a scan function according to the present invention. As shown in FIG. 4, the present invention has features in that a scan request ion 210 is shown at one side of the output unit, with which to easily attach an image file through the scanning device without performing complicated procedures while the user is preparing e-mails.

When a scan request signal is received, the mail preparation unit 120 divides the screen of the output unit into a first divide screen and a second divide screen. The body of the e-mail can be prepared on the first divide screen, and the image data received from the scanning unit can be edited on the second divide screen.

Even when a request for attaching an image stored in the storage unit 150, the mail preparation unit 120 also divides the screen of the output unit into a first divide screen and a second divide screen. The body of the e-mail can be prepared on the first divide screen, and a corresponding image data is upload from the storage unit and is edited on the second divide screen.

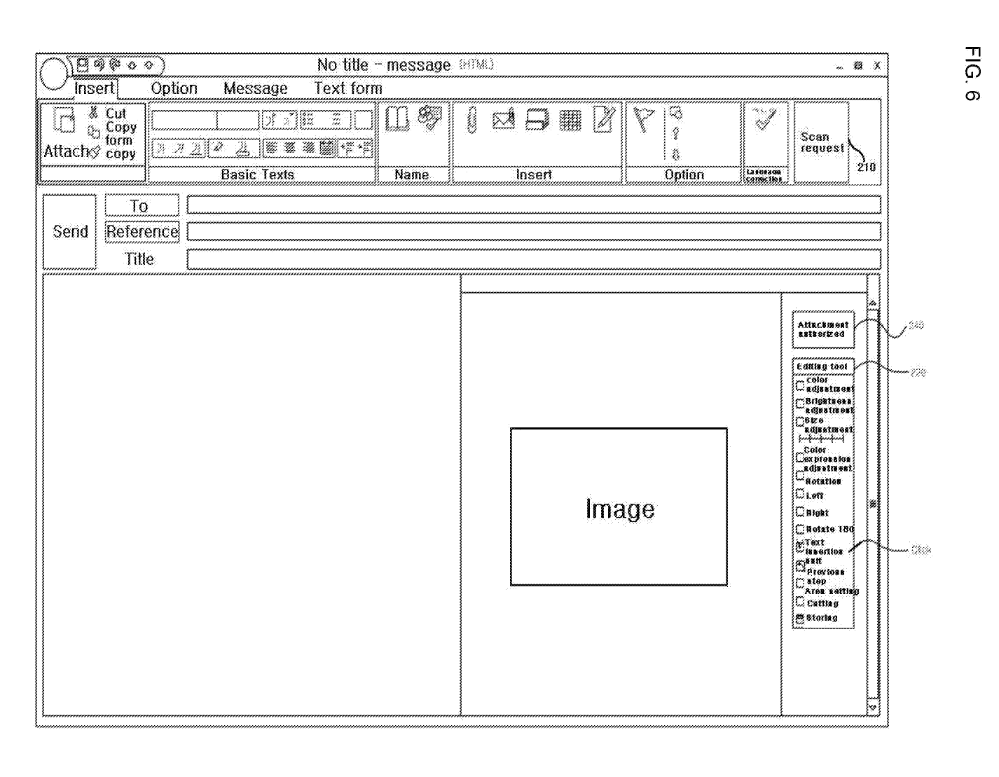

The mail preparation unit 120 is preferably equipped with an editing tool 220 by which to display the image data on the second divide screen and to edit the image data. At this time, the mail preparation unit 120 adjusts the size of the image data to fit the size of the second divide screen and outputs the size-adjusted image. FIG. 5 is a view for describing the operations of the mail preparation unit.

The editing tool comprises an area setting unit for setting a certain area of the image data; a cutting-off unit for cutting off a certain area of the image data; a rotation editing unit for rotating the direction of the image data; a size adjusting unit for adjusting the size of the image data; a color expression adjusting unit for adjusting the color expression of the image data; a brightness adjusting unit for adjusting the brightness of the image data; a text insertion unit for inserting the texts into the image data; a zooming unit for performing a zooming-in or zooming-out function of the image data; and a returning unit for allowing the current routine to the previous editing routine when the image data has been edited.

The image data of the present invention is outputted in a size-adjusted form to fit the size of the second divide screen. The editing tool 220 comprises an original copy output unit for showing an original size of the image data, and an adjusting output unit for adjusting the size to the width of the image data and outputting the same.

The user can edit the image data using the editing tool 220. The mail preparation unit 120 allows the image data to be edited in accordance with an editing handling signal by way of the editing tool 220.

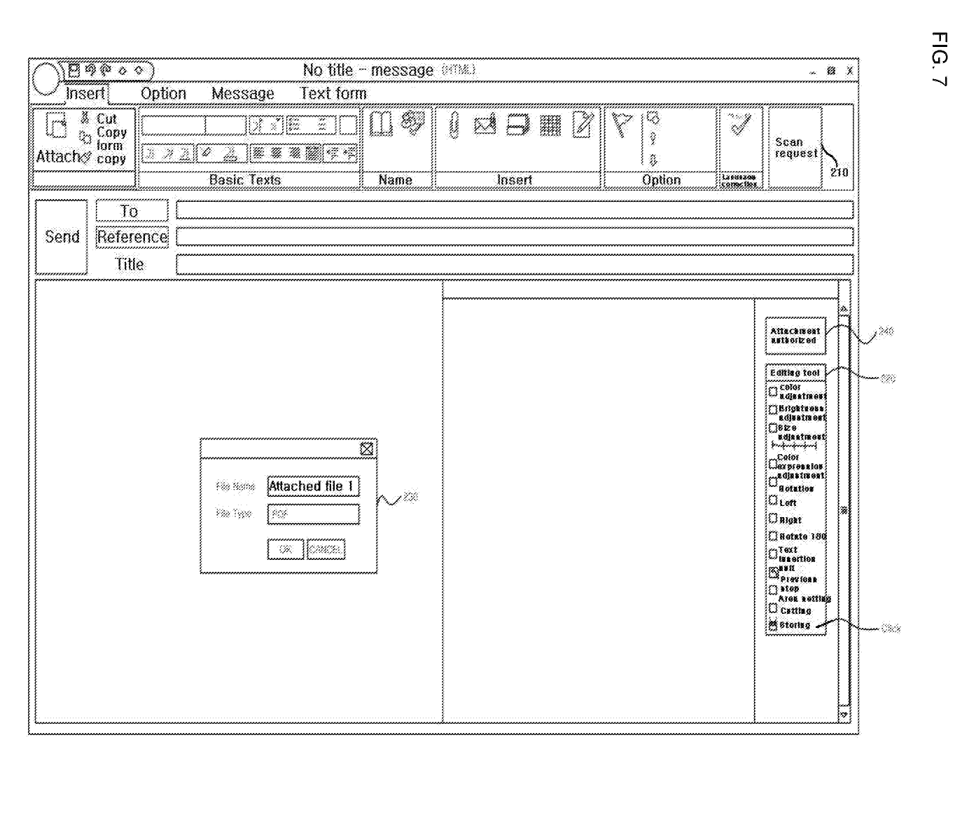

FIG. 6 is a view illustrating a state that texts are inputted into the image data as the user clicks the text insertion unit.

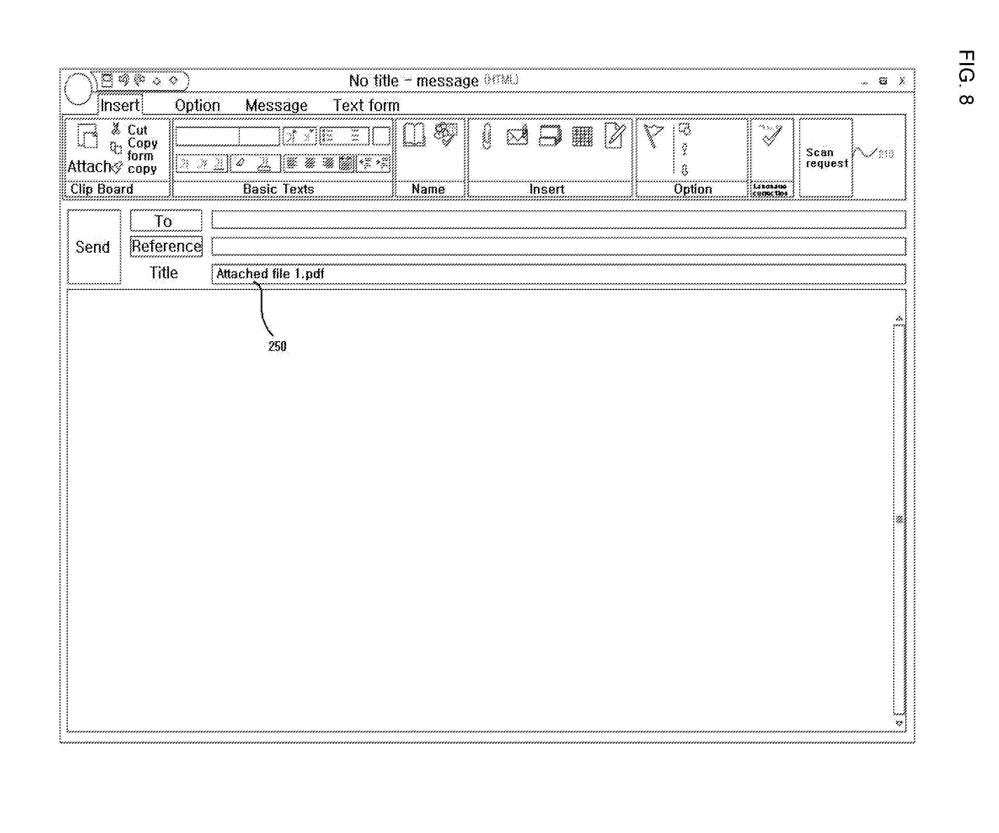

FIG. 7 is a view illustrating a state that the user clicks an icon linked to a storing operation. As shown in FIG. 7, when the user clicks, a storage setting window 230 is displayed for setting the name, format, etc. of the image data. The image data can be stored based on the contents inputted into the storage setting window 230. According to the present invention, the user can easily edit the image data attached to the mail while he is preparing the mail.

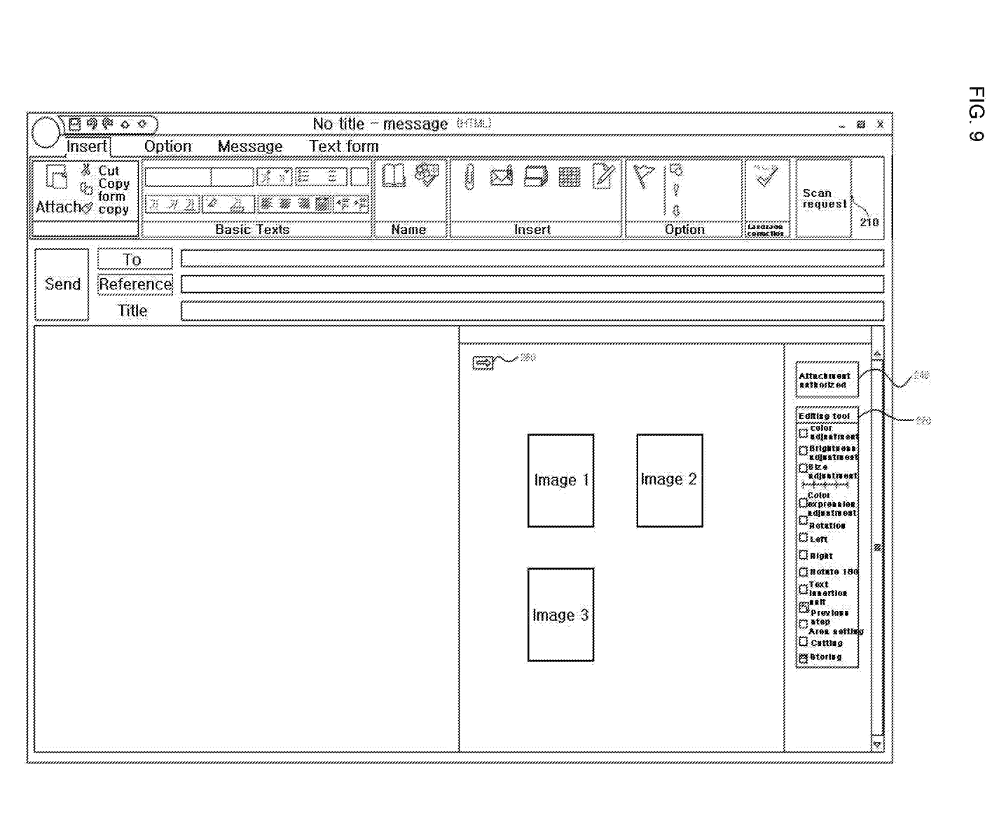

The mail preparation unit 120 proceeds with automatically attaching the edited image data to the e-mail when the editing of the image data is completed by the editing tool 220. When the input of the attached authorization icon 240 is detected, the mail preparation unit 120 decides that the editing of the image data is completed, and allows the image data to be attached to the e-mail. FIG. 8 is a view illustrating a state that the image data edited by the mail preparation unit is automatically attached.

The mail transmission unit 130 allows the e-mail prepared by the mail preparation unit to be transmitted to the external terminal device through the network.

The central control unit 140 controls the whole operations so that the user can transmit the e-mail.

The storage unit 150 stores the image data generated by the scanning unit 10 or the image data edited by the editing tool 220. At this time, it is preferred that the image data are tabled by dates. There may be used various kinds of storage medium such as EPROM, flash memory, external type memory, etc. depending on the capacity of the data stored in the storage unit 150.

The mail preparation unit 120 may receive a scan request signal for scanning multiple images. The mail preparation unit 120 allows the scanning unit 110 to scan multiple images and to generate multiple image data.

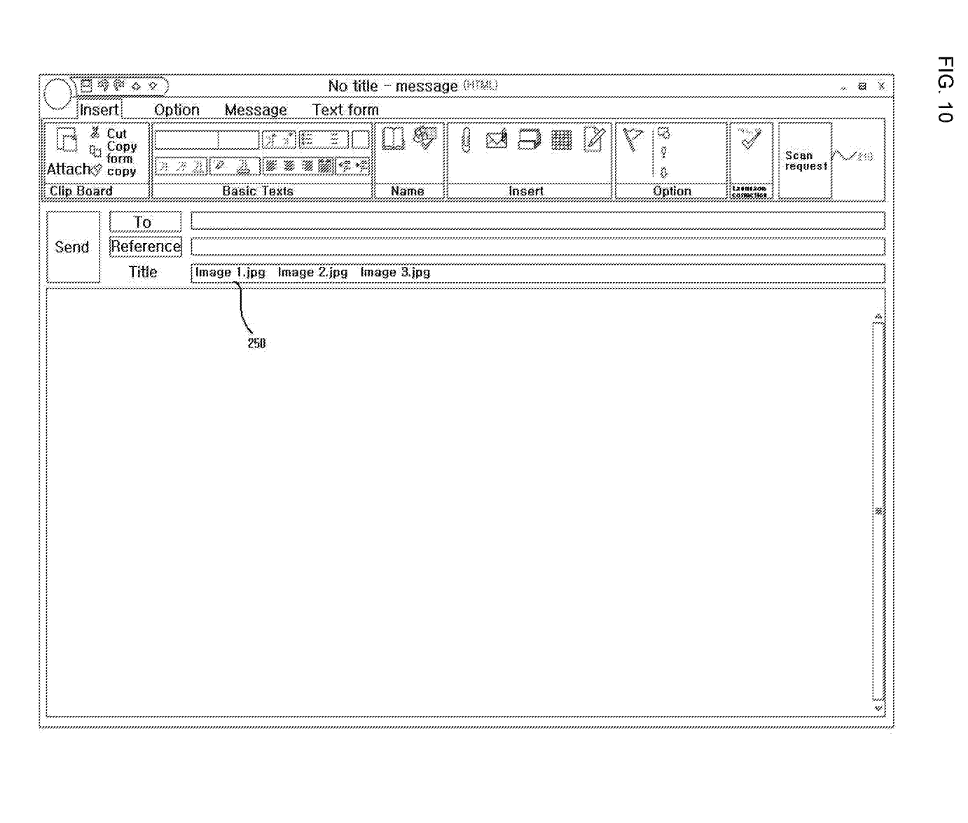

The mail preparation unit 120 displays on the second divide screen the multiple image data generated by the scanning unit 110. FIG. 9 is a view illustrating an output unit when multiple image data are generated. At this time, an image selection icon 260 is provided for selecting one image among a plurality of images. The user can select one image data using the image selection icon 260 and edit the image data using the editing tool 220.

FIG. 10 is a view illustrating a state that all images are attached to the e-mail when the editing of all images are completed.

The operations of the system provided with a scan function for transmitting e-mail according to the present invention will be described with reference to the accompanying drawings.

In the middle of the preparation of the e-mail, the mail preparation unit 120 may receive a scan request signal. At this time, it is possible to scan one or multiple images.

The mail preparation unit 120 commands the scanning unit 110 to perform a scanning work.

The mail preparation unit 120 divides the screen of the output into a first divide screen and a second divide screen. The proceeding state of the scan work can be confirmed on the second divide screen, and the preview image of the image data can be outputted on the output unit.

Afterward, the mail preparation unit 120 allows the contents of the body of the e-mail to be displayed on the first divide screen, and the editing of the image data generated by the scanning unit 110 is performed on the second divide screen. It is preferred that the image data are outputted on the second divide screen, and the editing tool 220 with which to edit the image data is provided along with them.

An image data attachment authorization signal is received via the input, the mail preparation unit 120 automatically attaches the image data to the e-mail. When the mail transmission unit 130 receives a request for transmitting the e-mail via the input unit, the e-mail is transmitted to the external terminal device via the network. The user of the external terminal device opens the e-mail and confirms the contents of the e-mail.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A system provided with a scan function for transmitting e-mail configured to transmit e-mail via a network, comprising:
a scanning unit which generates an image data by performing a scanning work;
a mail preparation unit which allows a user to prepare an e-mail, and when a scan request signal is received in the middle of preparation of e-mail, allows the scanning unit to perform a scanning work and allows a preview image of the image data to be outputted via the output unit so that the proceeding state of the scan work to be confirmed, and when an attachment authorization signal is received via an input unit, it allows the image data to be automatically attached to the e-mail; and
a mail transmission unit which allows the e-mail prepared by the mail preparation unit to be transmitted to an external transmission unit.

2. The system of claim 1, wherein when a scan request signal is received, the mail preparation unit divides the screen of the output unit into a first divide screen and a second divide screen, and on the first divide screen is prepared a body content of the e-mail, and on the second divide screen is edited an image received from the scanning unit.

3. The system of claim 2, wherein the mail preparation unit allows the image data from the scanning unit to be outputted on the second divide screen and provides an editing tool by which to edit the image data.

4. The system of claim 3, wherein the editing tool comprises:
an area setting unit for setting a certain area of the image data;
a cutting-off unit for cutting off a certain area of the image data;
a rotation editing unit for rotating the direction of the image data;
a size adjusting unit for adjusting the size of the image data;
a color expression adjusting unit for adjusting the color expression of the image data;
a brightness adjusting unit for adjusting the brightness of the image data;
a text insertion unit for inserting the texts into the image data;
a zooming unit for performing a zooming-in or zooming-out function of the image data; and
a returning unit for allowing the current routine to the previous editing routine when the image data has been edited.

5. The system of claim 3, wherein when the editing of the image data is completed by the editing tool, the mail preparation unit allows the edited image data to be automatically attached to the e-mail.

6. A method for transmitting an e-mail using a system provided with a scan function for transmitting e-mail configured to transmit e-mail via a network, comprising:
a step (A) in which a mail preparation unit receives a scan request signal in the middle of preparation of an e-mail;
a step (B) in which when the mail preparation unit receives a scan request signal in the step (A), the scanning unit is commanded to perform a scanning work;
a step (C) in which the mail preparation unit divides the screen of an output unit into a first divide screen and a second divide screen, and the content of the body of the e-mail is inputted via the first divide screen, and the image data generated in the step (B) is edited on the second divide screen; and
a step (D) in which when the mail preparation unit receives an image data attachment authorization signal via the input unit, the image data is automatically attached to the e-mail; and
a step (E) in which when the mail transmission unit receives a request for transmitting an e-mail prepared in the step (D), it transmits the e-mail to an external terminal device via the network.

7. The method of claim 6, wherein in the step (C), the image data generated in the step (B) are outputted on the second divide screen, and there is provided an editing tool by which to edit the image data.

8. The method of claim 7, wherein the editing unit comprises:
an area setting unit for setting a certain area of the image data;
a cutting-off unit for cutting off a certain area of the image data;
a rotation editing unit for rotating the direction of the image data;
a size adjusting unit for adjusting the size of the image data;
a color expression adjusting unit for adjusting the color expression of the image data;
a brightness adjusting unit for adjusting the brightness of the image data;
a text insertion unit for inserting the texts into the image data;
a zooming unit for performing a zooming-in or zooming-out function of the image data; and
a returning unit for allowing the current routine to the previous editing routine when the image data has been edited.
